(19) United States
(12) Patent Application Publication
(10) Pub. No.: US 2023/0249048 A1
(43) Pub. Date: Aug. 10, 2023

(54) Method For Synchronizing Extended and Physical Actions When Using Exercise Equipment

(71) Applicant: VR Simulations, Inc., New York, NY (US)

(72) Inventors: Ilya Pollokhin, New York, NY (US); Nan Lin Wen, New York, NY (US); Mikhail Zhavoronkov, Northville, MI (US)

(73) Assignee: VR Simulations, Inc., New York, NY (US)

(21) Appl. No.: 18/103,479

(22) Filed: Jan. 30, 2023

Related U.S. Application Data
(60) Provisional application No. 63/304,505, filed on Jan. 28, 2022.

(51) Int. Cl. A63B 71/06; G06T 19/00; A63B 24/00

(52) U.S. Cl. CPC A63B 71/0622; A63B 24/0062; G06T 19/006; A63B 2024/009; A63B 2071/0644; A63B 2071/0666; A63B 2220/803

(57) ABSTRACT

A method synchronizes headset output signals of an extended reality headset having a headset receiver, wherein the extended reality headset is worn by a user when the user is operating a piece of exercise equipment having an exercise transmitter to transmit an exercise output signal. A motion sensing detector detects motion of the user, wherein the motion sensing detector includes a motion transmitter to transmit a motion signal. The method begins with receiving the exercise output signal from the exercise transmitter using the headset receiver. The motion signal is then received from the motion transmitter using the headset receiver. The headset output signals are then synchronized as they are emitted by the extended reality headset to match the exercise output and motion signals such that the user can sense the headset output signals congruently with what the user can feel when exercising on the piece of exercise equipment.

### BACKGROUND ART

### Field of the Invention

The invention is related to a method for synchronizing an extended reality headset to actions of a user using a piece of exercise so that the user can use the piece of exercise equipment while wearing the extended reality headset (XRH).

### Description of the Related Art

Conventional 2D screen technology has enabled users to view screens (televisions, tablets, computer screens, phone screens and the like) while performing certain functions, from playing games, to driving vehicles, to exercising. When exercising, the ability to view an image through which the exerciser can pretend to be involved with may motivate or inspire the user to continue exercising. These are commonly shown on the screens that accompany some exercise equipment. For example, running up a hill on the screen may be coordinated with the treadmill increasing its elevation.

However, a user of a piece of exercise equipment may want to immerse herself in an extended reality headset (XRH). As such, there is a need in the art to synchronize the visuals created by the XRH with the operation of the exercise equipment, so the actions of the user are viewed by the user to be in sync with her actual movement as well as being in sync with the visuals created by the XRH.

### SUMMARY OF THE INVENTION

A method synchronizes headset output signals of an extended reality headset having a headset receiver, wherein the extended reality headset is worn by a user when the user is operating a piece of exercise equipment having at least one exercise transmitter to transmit an exercise output signal. At least one motion sensing detector detects motion of the user, wherein the at least one motion sensing detector includes a motion transmitter to transmit a motion signal. The method begins with receiving the exercise output signal from the exercise transmitter using the headset receiver. The motion signal is then received from the at least one motion transmitter using the headset receiver. The headset output signals are then synchronized as they are emitted by the extended reality headset to match the exercise output and motion signals such that the user can sense the headset output signals congruently with what the user can feel when exercising on the piece of exercise equipment.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a logic chart of one embodiment of a method to synchronize the XRH with the movements of the user using the exercise equipment;

FIGS. 2A and 2B are a graphic representation of a user incorporating one branch of the method;

FIGS. 3A and 3B are a graphic representation of a user incorporating a second branch of the method;

FIGS. 4A and 4B are a graphic representation of a user incorporating a third branch of the method;

FIGS. 5A and 5B are a graphic representation of a user incorporating a fourth branch of the method;

FIG. 6 is a perspective view of one embodiment of an XRH;

FIG. 7 is a side view of a user on a piece of exercise equipment showing schematically various locations where motion sensing devices may be located; and

FIGS. 8A and 8B are a graphic representation of a user incorporating a fifth branch of the method.

### DETAILED DESCRIPTION OF THE PREFERRED EMBODIMENT

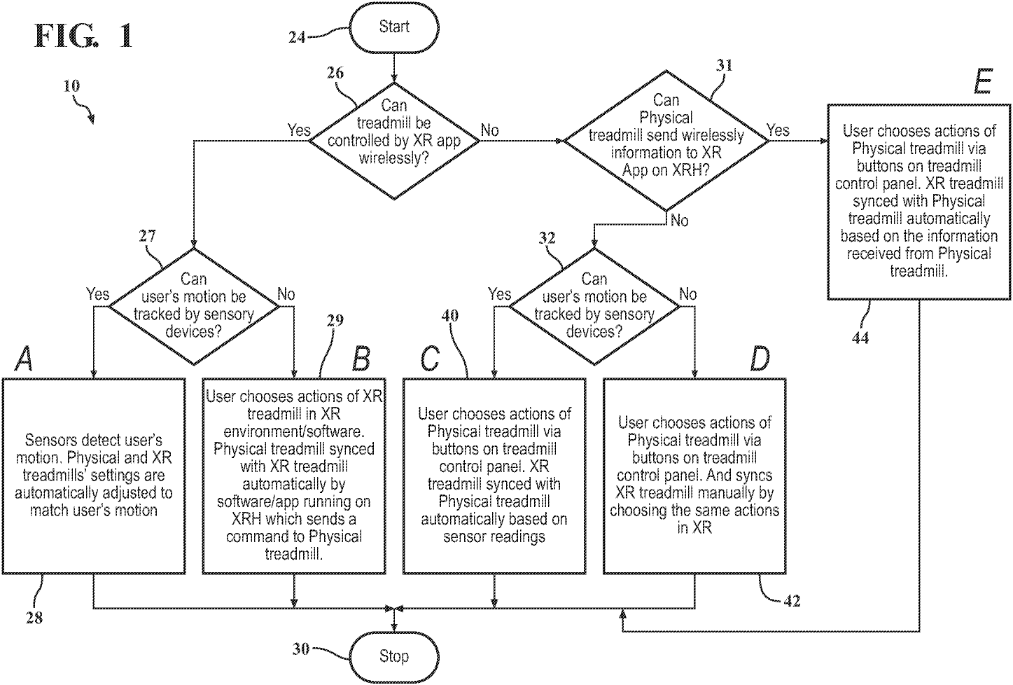

Referring to FIG. 1, a method is generally shown at 10. The method 10 synchronizes an XRH 12 with a piece of exercise equipment is generally indicated at 14. The XRH 12 is worn by a user 16 during exercise or use of the piece of exercise equipment 14. The XRH 12 includes a transmitter 13 and a receiver 15 (graphically represented in FIG. 6).

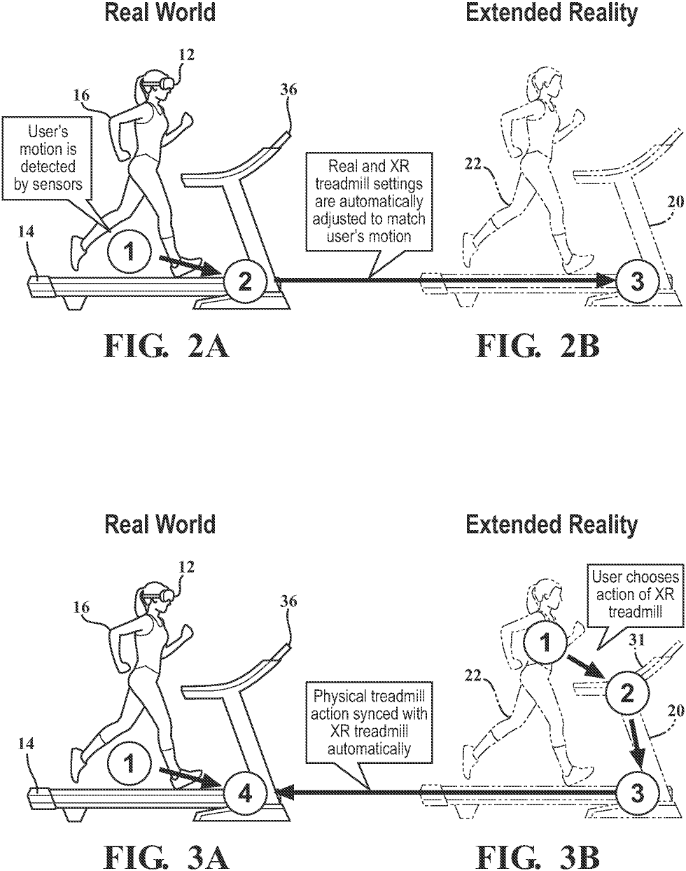

The XRH 12 either creates or models a virtual piece of exercise equipment 20 being used by a virtual user 22, both graphically represented in FIGS. 2B, 3B, 4B and 5B. The real exercise equipment 14 and virtual exercise equipment 20 are shown to be a treadmill. It should be appreciated by those skilled in the art that the piece of exercise equipment 14 and virtual exercise equipment 20 can be any type of exercise equipment, including stationary bicycles, elliptical trainers, rowing machines stair-steppers and the like.

Returning attention to FIG. 1, the method 10 begins at 24. The method 10 determines at 26 whether piece of exercise equipment 14 can be controlled by the XRH 12. If yes, the method 24 begins to operate through pathway A, represented graphically in FIGS. 2A and 2B. Once it is determined that the piece of exercise equipment 14 can be controlled using the XRH 12, the method transmits equipment control commands from the XRH 12 to the piece of exercise equipment 14 and the piece of exercise equipment 14 operates accordingly. The equipment control commands include, but are not limited to, speed, elevation, operational programming, etc., and they can all be controlled by virtually through the XRH 12. The piece of exercise equipment 14 transmits an exercise output signal back to the XRH 12 as a feedback loop.

The method 10 then senses at 27 whether any motion sensor 34 (discussed in greater detail subsequently) are active/present. If so, the method 10 receives a motion signal from at least one motion sensor 34 and adjusts the piece of exercise equipment 14 and the output of the XRH 12 accordingly at 28. The method 10 continues to loop as long as the user 16 is operating the method 10 in this mode.

A second pathway B is employed if at least one motion sensor 34 is not detected. In pathway B, the method 10 receives inputs from the user 16 at 29 through use of the XRH 12. In other words, the user 16 uses the XRH 12 to input the parameters in which the user 16 wants to exercise. The software loaded into the XRH 12 is designed to receive inputs from user 16 through virtual controls 31 (FIG. 3B) and transmits those equipment control commands to the piece of exercise equipment 14. Once the equipment control commands are received by the piece of exercise equipment 14, the piece of exercise equipment 14 operates accordingly. The equipment control commands include, but are not limited to, speed, elevation, operational programming, etc., and they can all be controlled by virtually through the XRH 12. The method 10 terminates at 30 allowing the XRH 12 and the piece of exercise equipment 14 to continue to operate until the operation is modified by receipt of a new motion signal or a new equipment control command.

Returning attention to decision diamond 26, if it is determined at 26 that the piece of exercise equipment 14 is not controllable using the XRH 12, the method 10 does not operate in either of pathways A and B, but determines at 31 whether the piece of exercise equipment 14 can transmit data to the XRH 12. If there is no electronic communication between the piece of exercise equipment 14 and the XRH 12 in either direction, the method 10 investigates at 32 whether the at least one motion sensor 34 is used by the user 16 or whether the at least one motion sensor 34 is installed on or outside of the piece of exercise equipment 14. One or more motion sensors 34 can be utilized.

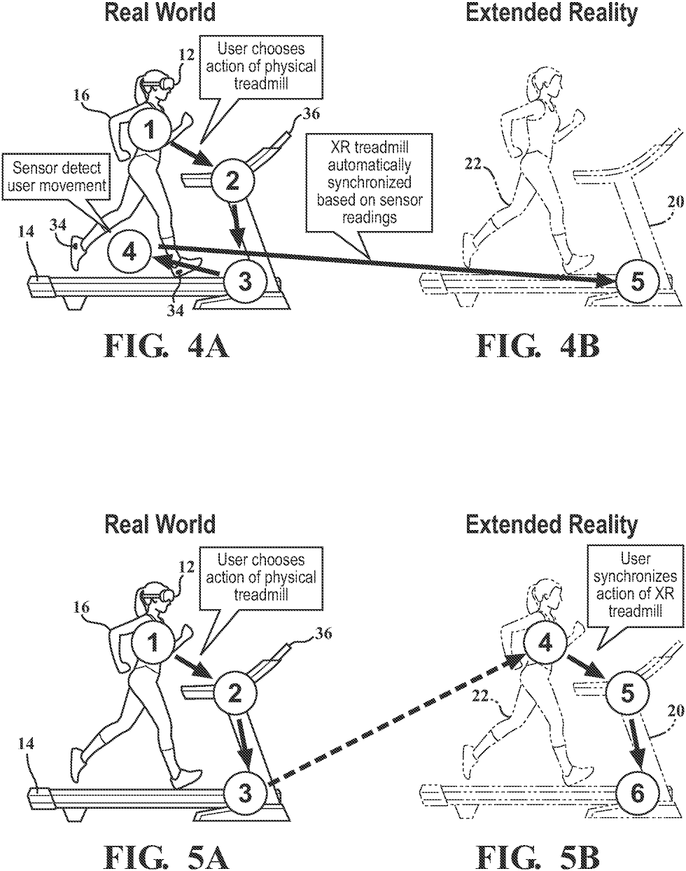

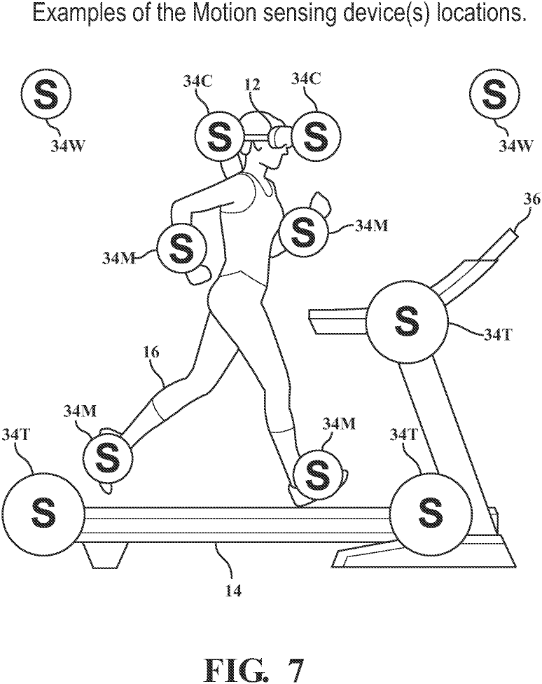

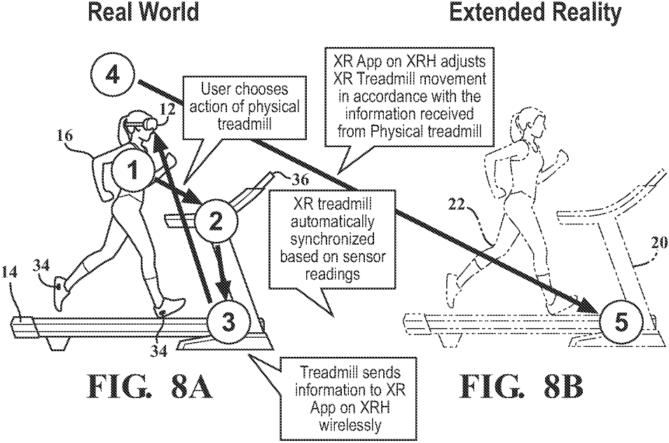

It should be appreciated by those skilled in the art that the at least one motion sensors 34 may include body worn sensors (as shown in FIG. 4A), speed or cadence sensors (depending on the type of exercise equipment used), imaging technology such as a camera with programming to detect motion), and the like. As is shown in FIG. 6, the at least one motion sensor 34 may include cameras 34C located on and in electronic communication with the XRH 12 (multiple cameras 34C are shown in FIG. 6, with only needing one to provide input for the operation of the method 10). Referring to FIG. 7, multiple locations graphically represented by an S in a circle show various locations where the at least one motion sensor 34 can be located. These include, but are not limited to motion sensors 34C that are cameras mounted to the XRH 12, motions sensors 34M worn by the user 16, motion sensors 34T mounted to the piece of exercise equipment 14, and motion sensors 34W mounted to structures adjacent the piece of exercise equipment, such as a wall (not shown). All of these motion sensors 34C, 34M, 34T, 34W are alternative locations where the at least one motion sensor 34 may be located. As stated above, this list of motion sensors 34 is not exhaustive.

Returning attention to FIG. 1, if at least one motion sensor 34 is being utilized by the user 16, the user 16 inputs controls directly into the piece of exercise equipment 14 through its control panel 36 at 40 and the XRH 12 syncs itself using the output of the at least one motion sensor 34. This is represented as pathway C in FIG. 1. Once synced, the method 10 terminates at 30 until the motion signal generated by the at least one motion sensor 34 changes by more than a predetermined amount.

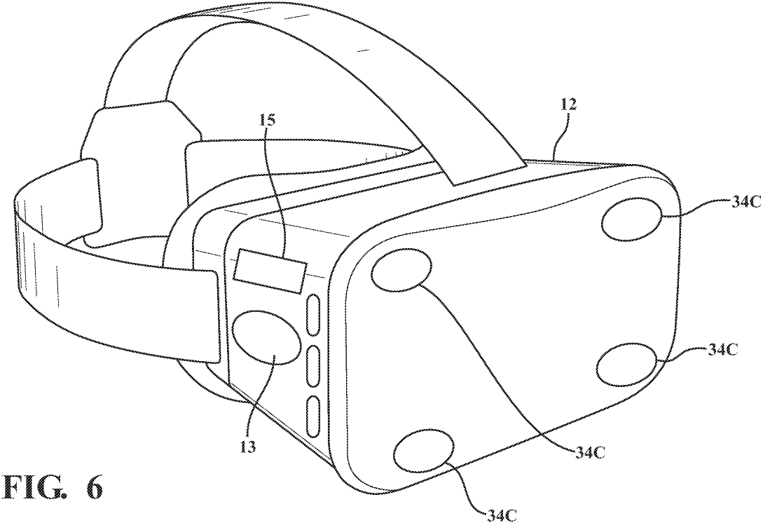

If the investigation at 32 determines the user 16 is not using at least one motion sensor 34, the method 10 then requires the user 16 to enter input parameters directly into the XRH 12 and the piece of exercise equipment 14 at 42. This is pathway D in FIG. 1. This is duplicative, but necessary if there are absolutely no incoming signals, such as the motion signal or the exercise output signal, into the XRH 12 to identify the operation of the piece of exercise equipment 14, either directly from the piece of exercise equipment 14 or indirectly through the at least one motion sensor 34 utilized by the user 16. In this mode (FIGS. 5A and 5B), the user 16 is required to see the piece of exercise equipment 14 or its digital rendering to enter the commands. The user 16 also needs to see the digital controls of the exercise equipment 20 to enter the commands into the XRH 12. Alternatively, the XRH 12 may have a simple graphic void of the virtual exercise equipment 20 allowing the user 16 to input parameters of operation into the simple graphic (not shown) so the user 16 does not need to see both the real 14 and the virtual 20 pieces of exercise equipment (with the XRH 12 in what is commonly referred to as passthrough mode).

Returning attention to decision diamond 31 in FIG. 1, if it is determined that the piece of exercise equipment 14 can communicate with the XRH 12 and send the exercise output signal thereto, the method 10, the XRH 12 will synchronize with the piece of exercise equipment 14 at 44. This is shown in FIG. 1 as pathway E. As such, the user 16 inputs commands directly into the control panel 36. Those inputs will be transmitted to the XRH 12 at 44 in the exercise output signal allowing it to remain synchronized with the piece of exercise equipment 14.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A method for synchronizing movement of a user, operating a piece of exercise equipment and wearing an extended reality headset, with a video output displayed on at least one video screen of the extended reality headset, and movement of the piece of exercise equipment, the method comprising the steps of:
determining whether the piece of exercise equipment can be controlled by the extended reality headset;
detecting at least one motion sensing device providing a motion output signal;
obtaining the motion signal from the at least one motion sensing device representing movement of the user operating the piece of exercise equipment;
analyzing data of the motion output signal to create motion commands;
transmitting the motion commands to the piece of exercise equipment through the extended reality headset; and
displaying the video output on the at least one screen of the extended reality headset, such that the steps of transmitting the motion commands and displaying the video output are both performed by the extended reality headset achieves synchronization of the video output and of the movement of the piece of exercise equipment, which in turn, are aligned with the movement of the user.

2. A method as set forth in claim 1 including the step of entering equipment control commands for the piece of exercise equipment into the extended reality headset to control the piece of exercise equipment.

3. A method as set forth in claim 2 wherein the at least one motion sensing device is worn by the user.

4. A method as set forth in claim 2 wherein the at least one motion sensing device is secured to the piece of exercise equipment.

5. A method as set forth in claim 2 wherein the at least one motion sensing device is a camera built into the extended reality headset.

6. A method as set forth in claim 2 including the step of inputting equipment control commands through the extended reality headset to control the piece of exercise equipment.

7. A method as set forth in claim 2 wherein the at least one motion sensing device is spaced apart from the extended reality headset and the piece of exercise equipment.

8. A method for synchronizing movement of a piece of exercise equipment for a user wearing an extended reality headset with a video output displayed on at least one video screen of the extended reality headset, and the video output on the at least one video screen, the method comprising the steps of:
determining whether the piece of exercise equipment can be controlled by the extended reality headset;
entering equipment control commands for the piece of exercise equipment into the extended reality headset;
sending the equipment control commands to the piece of exercise equipment through the extended reality headset;
displaying the video output on the at least one screen of the extended reality headset, such that the steps of transmitting the equipment control commands and displaying the video output are both performed by the extended reality headset achieves synchronization of the video output and of the movement of the physical piece of exercise equipment.

9. A method as set forth in claim 8 including the step of inputting equipment control commands through the extended reality headset to control the piece of exercise equipment.

10. A method for synchronizing movement of a piece of exercise equipment for a user wearing an extended reality headset with a video output displayed on at least one video screen of the extended reality headset, and the video output on the at least one video screen, the method comprising the steps of:
determining whether the piece of exercise equipment can be controlled by the extended reality headset;
identifying whether the piece of exercise equipment can communicate with the extended reality headset;
detecting whether a motion sensor can communicate with the extended reality headset;
transmitting motion signals from the motion sensor to the extended reality headset;
entering equipment control commands for the piece of exercise equipment directly into the piece of exercise equipment; and
displaying the video output on the at least one screen of the extended reality headset, such that the step of displaying the video output is both performed by the extended reality headset and is synchronized with the motion signal received from the motion sensor.

11. A method as set forth in claim 10 wherein the at least one motion sensing device is worn by the user.

12. A method as set forth in claim 10 wherein the at least one motion sensing device is secured to the piece of exercise equipment.

13. A method as set forth in claim 10 wherein the at least one motion sensing device is a camera built into the extended reality headset.

14. A method as set forth in claim 10 wherein the at least one motion sensing device is spaced apart from the extended reality headset and the piece of exercise equipment.

15. A method for synchronizing movement of a piece of exercise equipment for a user wearing an extended reality headset with a video output displayed on at least one video screen of the extended reality headset, and the video output on the at least one video screen, the method comprising the steps of:
determining whether the piece of exercise equipment can be controlled by the extended reality headset;
identifying whether the piece of exercise equipment can communicate with the extended reality headset;
detecting whether a motion sensor can communicate with the extended reality headset;
manually entering action signal into the extended reality headset when no motion sensor is detected;
entering equipment control commands for the piece of exercise equipment directly into the piece of exercise equipment; and
displaying the video output on the at least one screen of the extended reality headset, such that the step of displaying the video output is both performed by the extended reality headset and is synchronized with the actions signal.

16. A method for synchronizing movement of a piece of exercise equipment for a user wearing an extended reality headset with a video output displayed on at least one video screen of the extended reality headset, and the video output on the at least one video screen, the method comprising the steps of:
determining whether the piece of exercise equipment can be controlled by the extended reality headset;
determining whether the extended reality headset can receive an equipment signal from the piece of exercise equipment representing an exercise mode of operation in which the piece of exercise equipment is operating;
identifying whether the piece of exercise equipment can communicate with the extended reality headset;
detecting whether a motion sensor can communicate with the extended reality headset;
entering equipment control commands for the piece of exercise equipment directly into the piece of exercise equipment; and
displaying the video output on the at least one screen of the extended reality headset, such that the step of displaying the video output is both performed by the extended reality headset and is synchronized with the equipment signal received from the piece of exercise equipment.

17. A method as set forth in claim 16 including the step of manually entering action signal into the extended reality headset when no motion sensor is detected.

18. A method for synchronizing headset output signals of an extended reality headset having a headset receiver, the extended reality headset to be worn by a user when the user is operating a piece of exercise equipment having at least one exercise device and at least one exercise transmitter to transmit an exercise output signal, and at least one motion sensing detector to detect motion of the user, wherein the at least one motion sensing detector includes at least one motion transmitter to transmit a motion signal; the method comprising the steps of:
receiving the exercise output signal from the at least one exercise transmitter using the headset receiver;
receiving the motion signal from the at least one motion transmitter using the headset receiver; and
synchronizing the headset output signals being emitted by the extended reality headset to match the exercise output and motion signals such that the user can sense the headset output signals congruently with what the user can feel when exercising on the piece of exercise equipment.
